(19) United States
(12) Patent Application Publication
(10) Pub. No.: US 2020/0326683 A1
(43) Pub. Date: Oct. 15, 2020

(54) Secure 3D Printing

(71) Applicant: Toybox Labs Inc, Oakland, CA (US)

(72) Inventors: Zachary Oligschlaeger, Seattle, WA (US); Benjamin Baltes, Oakland, CA (US); Jennifer Chin, Oakland, CA (US)

(21) Appl. No.: 16/846,409

(22) Filed: Apr. 13, 2020

Related U.S. Application Data
(60) Provisional application No. 62/833,676, filed on Apr. 13, 2019.

(51) Int. Cl. G05B 19/4099; H04L 9/08; H04L 9/14; B33Y 50/02

(52) U.S. Cl. CPC G05B 19/4099; H04L 9/0819; H04L 9/14; G05B 2219/36542; B33Y 50/02; G05B 2219/35134; G05B 2219/49023; H04L 9/088

(57) ABSTRACT

A system for secure 3D printing, the system comprising a server computer configured to transmit cryptographic key upon initiation of a print phase, each of the cryptographic keys being unique to individual 3-dimensional objects and unique to individual 3D printers. A 3D printer is configured to print 3-dimensional objects. The 3D printer comprises a network interface, print actuation devices, a processor, and a memory device coupled to the 3D printer containing encrypted printing instructions and computer code for receiving a plurality of cryptographic keys unique to the 3D printer and pertaining to a particular 3-dimensional object, decrypting encrypted printing instructions for printing the particular 3-dimensional object, and performing the decrypted printing instructions to print the particular 3-dimensional object.

### CROSS-REFERENCE TO RELATED APPLICATIONS

This application claims priority to provisional application no. 62/833676, titled “Secure 3D Printing” to Oligschlaeger et. al and filed on Apr. 13, 2019, which is herein incorporated by reference in all of its entirety.

### BACKGROUND

In today's technological environment, 3D printing can be used to form pre-designed objects out of material. One method of 3D printing that can be used is fused filament fabrication. In such a method, a continuous filament of material is forced out of a printer head to print an object layer by layer. Once all layers have been completed, the object can be removed from the printer and used. This method of 3D printing, and others, may provide users with the ability to produce goods conveniently within their own home.

Although 3D printing promises many potential benefits, there are still areas in need of technological improvement, namely security and the control over distribution of copyrighted material. For example, creators may be hesitant to make their designs available by 3D printing for fear of thieves and counterfeiters pirating design files and creating unauthorized copies for personal use or for illegal distribution. Furthermore, any modifications made to a printing process to improve security should be balanced against ease of use, reliability, and entertainment value, especially for 3D printers intended for novice users and/or children. Therefore, there is a need for securely executing a printing process, with considerations to providing an optimal user experience.

Embodiments of the invention address these and other problems, individually and collectively.

### BRIEF DESCRIPTION OF DRAWINGS

FIG. 1 shows an illustration of an exemplary 3D printer according to embodiments.

FIG. 2 shows a system for secure 3D printing according to embodiments.

FIG. 3 shows a block diagram of a server computer for enabling secure 3D printing according to embodiments.

FIG. 4 shows a block diagram of a secure 3D printer according to embodiments.

FIG. 5 shows a swim lane diagram for securely connecting to a 3D printing service according to embodiments.

FIG. 6 shows a flow diagram of a method for secure 3D printing according to one embodiment.

FIG. 7 shows a flow diagram of a method for enabling a secure 3D printing process according to embodiments.

FIG. 8 shows a flow diagram of a method for estimating a print time according to one embodiment.

### DETAILED DESCRIPTION

Before further describing embodiments, it may be useful to define some relevant terms.

A “3-dimensional model” or “3D model” may refer to a computer-generated model having a specified form in three-dimensions. For example, the 3D model may have distinct specifications and size. A “3D printed object” may refer to an object printed according to a 3-dimensional model. For example, a 3-dimensional model may be associated with printing instructions which a 3D printer can execute to build the object. Objects can include everyday objects, replacement parts, toys, or any other specified component. In some instances, the 3D model may take the form of a CAD model, and slicing software may be required to translate the model into computer numerical control language that a specific type or model of 3D printer may understand. In other words, additional processing may be needed to process model information into a format that a particular printer can convert into control signals for its corresponding actuation devices that perform the actual print maneuvers. For example, given a 3D model, control parameters and other characteristics of a 3D printer, and/or specific settings and preferences of a user, slicing software may generate a suitable g-code file that is calculated to best reproduce a 3-dimensional object on a user's printer, and according to the designer's intent.

“3D printing” may refer to printing of a 3-dimensional model. A common form of 3D printing is additive manufacturing, although 3D printing can be achieved using a variety of techniques. Techniques commonly known in the art may include fused deposition modeling (FDM), selective laser melting (SLM), electronic beam melting (EBM), laminated object manufacturing (LOM), binder jetting (BJ), among others. A “3-dimensional object printer” or “3D printer” may refer to an apparatus for 3D printing. With respect to types of 3D printing, “Fused deposition modeling” and “fused filament fabrication” are sometimes used interchangeably. Some non-limiting examples of fused filament fabrication 3D printers include Createbot Supermini, Maker Replicator, Lulzbot Taz, Wanhao Duplicator i3, to name a few.

A “print phase” or “operational phase” of a 3D printer may refer to a controlled process of printing a 3D model. The controlled process may include the execution of printing instructions for the 3D model by the 3D printer. For example, an operational phase can start when printing instructions are first initiated and may terminate when the model has been fully printed.

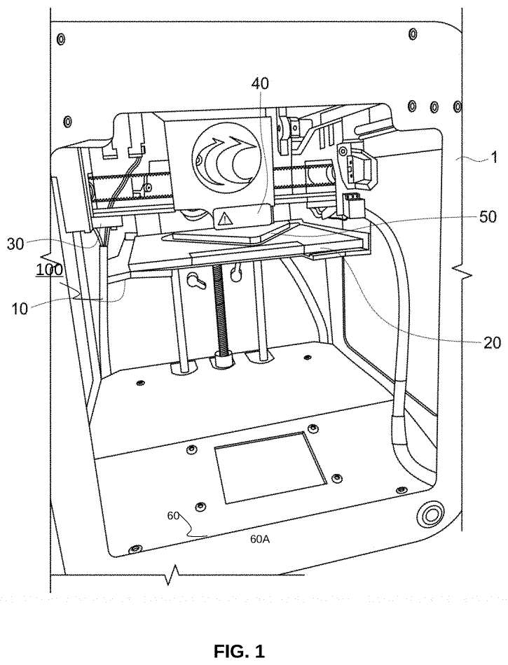

Embodiments of the invention will now be described in greater detail. FIG. 1 shows an illustration of an exemplary 3-D printer according to embodiments. Printer apparatus 100 (sometimes referred to herein as “the 3D printer” or simply “printer” 100) may comprise a printer body (1), and a build base (10) coupled to the printer body (1). In one embodiment, the printer apparatus 100 may further comprise a build surface (20) that can be temporarily attached, detached, and reattached to the build base (10). Printer apparatus 100 may further comprise a printer head structure (30) above the build base (10), which may include a gantry or other structure for controllably moving a nozzle (40) as it ejects molten material during a print process. In embodiments, a molten printing material, which may be a thermoplastic substance or other polymer filament that can be fed into printer 100, may be ejected from nozzle (40) and may accumulate on the pliable build surface (20) to extrude a three-dimensional object of predetermined shape.

A processor of the 3D printer may execute printing instructions for a 3D model. The printing instructions may comprise sequences of printing maneuvers to be performed by one or more actuation devices coupled to various components of the 3D printing apparatus and initiating controlled movement thereof. In some embodiments, the printing instructions may comprise numerical controls, such as in the form of g-code. The instructions may be, for example, predetermined and timed control movements performed at the printer head structure (30) and a controlled flow rate of extruding material through the nozzle (40). Thus, a 3D model can be printed layer by layer to form a 3D object. In one embodiment, movement of the rigid build base (10) may also be controllable by the processor. For example, an actuator of printer apparatus 100 may be configured to slide the rigid build base (10) closer or farther away from nozzle (40) during a printing process. In one embodiment, printing instructions may be sent to printing apparatus 100 over a network (e.g. WiFi, Bluetooth, etc.). As such, printing apparatus 100 may further comprise one or more network interfaces. Although not explicitly illustrated in FIG. 1, it should be understood that the processor, one or more computer-readable mediums, and the one or more network interfaces of the printing apparatus 100 may be located within, or coupled to, a housing of the printing apparatus, such as within the printer body (1) and/or a dedicated electronics and software portion 60. The dedicated electronics and software portion may further comprise a display device 60A.

In embodiments, printer apparatus 100 may comprise one or more computer-readable mediums, such as memory stores or memory devices comprising instructions executable by the processor of the 3D printing apparatus. In some embodiments, the one or more computer-readable mediums may comprise a memory device that can be locally coupled to a processor of the 3D printer, so as to store and provide executable print instructions and/or other data and commands. As one example, the memory device may be an external memory device that may be connected to the 3D printer via known forms of communication interfaces, such as a USB storage device, external hard drive, or the like.

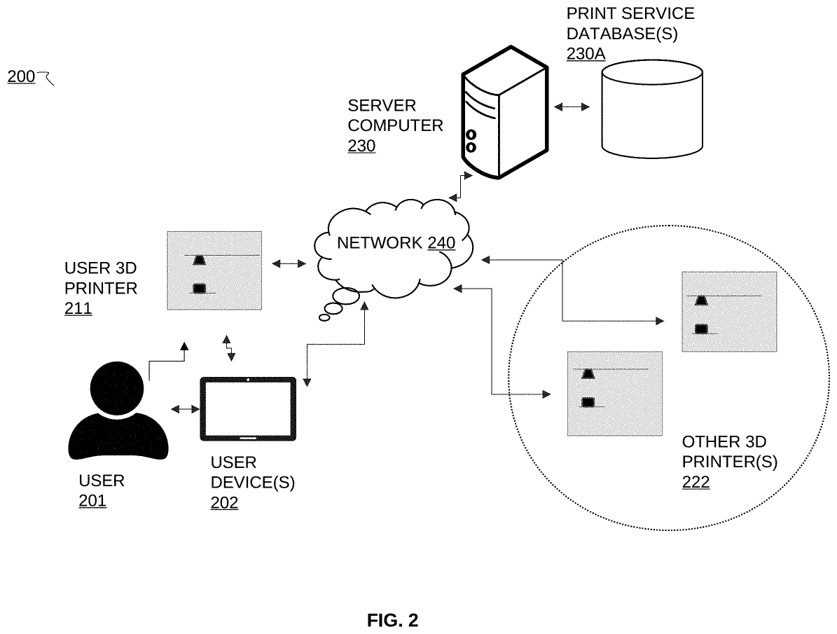

In one embodiment, the numerical controls of the 3D printer may be encoded in a manner unique to the 3D printer 100. A provider of a 3D printing service (e.g. a server/server computer, such as server computer 230 of FIG. 2) may encode print instructions for a 3-dimensional object according to a known encoding function that is mapped to the printing apparatus 100 (e.g. based on hardware identifier which may be linked to the encoding function in a stored table). When a print for printing apparatus 100 is requested, the provider may encode the printing instructions in a manner specific to the individual 3D printer 100 (which may be different from other 3D printers of similar build), such as by passing the contents of a g-code file through the encoding function. The encoded output may then be sent to the printing apparatus 300 as printing instructions encoded for specific use only by the 3D printer 100. Upon receipt of the encoded instructions, the processor of printing apparatus 100 may execute the encoded print instructions as control signals for the one or more actuation devices during a print phase of the 3-dimensional model. This printing apparatus 100 may be manufactured such that its processor may directly execute the print maneuvers in their encoded form, and such that only the provider “knows” or maintains secure storage of the encoding function. As such, the solution provided may add additional security to, or in lieu of, complex encryption methods, as only the individual printing apparatus can understand the delivered instructions and at the firmware level (i.e. in read-only memory of the printing apparatus 100). In some implementations, the encoding method may be combined with standard public-private key encryption, such as delivery of the encoded instructions over a standard secure communication channel, as known to those in the art. Furthermore, encoded printing instructions as described, may be used in combination with other secure 3D printing methods, such as those described further below.

Typically, in prior systems, 3D printers rely on g-code files to print 3-dimensional objects and the g-code files were able to be used across printers of the same build. In contrast, the encoding-based method described herein creates a unique set of g-code instructions for each printer, resulting in a secure file that does not need to be reformatted into a common form (e.g. cleartext or other consistent language) to work on a given printer. It is should be understood, that according to embodiments, each printer may have its own unique language or encoded format that amounts to more than just a mere cipher, although in some embodiments, a cipher may be used. Each printer is comprised of a different set of commands and a different translation for movements, for example, ‘MOVE X10 Y10’ could be ‘KPW X14.5 Y3.2’ on another printer of the same build and ‘OWE $EA EO1’ on yet another printer of the same build. In one embodiment, the specific method of encoding for each printer may change, where every printer can follow a different set of rules for processing instructions from one another. As an example, one printer may use a simple cipher while another can use a rolling cipher, and another printer may incorporate a completely different method altogether. In yet another embodiment, the printers may utilize similar encoding frameworks or slight variants thereof. A provider or server computer (e.g. server computer 230 of FIG. 2) knows each printer's unique encoding language and translates g-code to the unique encoding language prior to sending requested instructions. The method is more powerful than prior methods and systems that are completely dependent on encryption, or that may be solely dependent on encryption. In said prior systems, decrypted information can potentially be pulled out of memory by an attacker during a decryption stage and can be used on printers of similar builds.

FIG. 2 shows a system for secure 3D printing according to embodiments. In embodiments, the computing devices of system 200 as shown, may partition computing tasks and exchange resources as part of a distributed system, for example, according to a client-server model in various implementations. System 200 may comprise a user 3D printer 211 for operation by a user 201. The user 3D printer 211 may be the same printer as printing apparatus 100 of FIG. 1. The user 201 can operate the user 3D printer 211 using his or her user device(s) 202. For example, user device(s) 202 may be a tablet computer, phone, laptop computer, wearable device, etc., and the user may select designs for print and submit other commands for user 3D printer 211 using one or more input devices of, or coupled to, the user devices(s). One or more graphical user interfaces (GUI) may be provided and displayed to the user 201 on a display of the user device(s), and the user may press buttons, speak voice commands, type in instructions, and/or select icons corresponding to commands communicated to the user 201 via different display elements of the GUI. Communications between the user device(s) 202 and user 3D printer 211 may occur over various communication interfaces and standard communications protocols (e.g. through Bluetooth, WiFi, IR, etc.).

System 200 may further comprise a network 240 over which instructions and data may be communicated between a server computer 230, user device(s) 202, user 3D printer 211, and other 3D printers 222. For example, the network 240 may be the internet and the server computer 230 may be a server that may perform computations and provide services in conjunction with various tasks to be performed for remote devices, such as for providing cloud-based services, management of accounts of users, provisioning of data to the remote devices, etc. As shown by FIG. 2, the remote devices may be devices participating in a 3D printing process, and the services provided by the server computer 230 may include 3D printing services, such as displaying and providing access to 3D models, authorization of prints, generation and delivery of printing instructions, to name a few. In some embodiments, selection of 3-dimensional objects for printing, modifying/designing prints, purchase of prints, and other user inputs made to a printing service may be made at the user device(s) 202 and transmitted directly to the server computer 230 over network 240 in addition to the user 3D printer 211. In another implementation, the server computer 230 may act as an intermediary between the user 3D printer 211 and the user device(s) 211, performing such tasks as forwarding messages and executing responses to user actions. Server computer 230 may further be coupled to or have access to a print service database(s) 230A, which may store data relating to various services provided, such as user account data, data for print files, data relating to permissions and other authentication and authorization factors, historical data relating to printer activities and requests, payment confirmations, etc.

Server computer 230 may further be connected to other 3D printer(s) 222 over network 240, which may be 3D printers of other users that are not user 201, or simply any network-enabled 3D printer that is not user 3D printer 211 that may potentially attempt to make requests to the server computer 230. For example, the other 3D printer(s) may be 3D printers of the same build, model, or brand as user 3D printer 211, but that may have a different hardware identifier (hardware ID) or may be associated with a different user account than that of user 201. A suitable hardware ID may include a MAC address, although other types of unique identifiers known in the art can be used. In some embodiments, the other 3D printer(s) 222 may be also be the same type of 3D printer as printing apparatus 100 of FIG. 1 (e.g. the same model or manufacturer), or at least one of similar build (e.g. similar size, print characteristics, and/or components).

In certain embodiments, printing instructions for printing a model of a 3-dimensional object may be transmitted from server computer 230 and stored in encrypted form in user 3D printer 211 and other 3D printer(s) 222. The encrypted printing instructions may be stored locally in an accessible memory device of the 3D printer. When a 3-dimensional object is ready for print, the necessary cryptographic keys for decrypting the printing instructions may be requested or retrieved from the server computer 230 by the user 3D printer 211, for example, prior to or during a print phase of the 3-dimensional object by the 3D printer. In some embodiments, the encrypted instructions are stored as a plurality of encrypted parts. For example, a file for a sliced 3D object may be partitioned into separate parts each relating to a different set of printing instructions, which may then be individually encrypted using separate cryptographic keys. The partitioning of the printing instructions may be based on file size (e.g. each part is of a predetermined file size), stage in printing process (e.g. each part corresponds to a certain predefined point in the print process or level of progress), number of lines of code (e.g. break g-code file after every 10 lines of code), according to a random or pseudo-random process, or according to calculations that a certain partitioning will lead to the minimal amount of network latency. In additional implementations, the printing instructions may be partitioned according to characteristic elements of the 3-dimensional object (e.g. top, middle, bottom or head, torso, legs, feet, etc.). Each of the encrypted parts in the plurality of encrypted parts may require a separate and unique cryptographic key that is different from the other encrypted parts. For example, in addition to unique sets of cryptographic keys for each 3D model and for each 3D printer (each hardware ID), each partition of a g-code file may require a different cryptographic key to uncover its contents in clear text/original non-encrypted form. Additionally, the delivery of each cryptographic key may be limited in that it may be required to request and/or send over each key individually and at separate points in time during the print phase of the 3-dimensional object. For example, cryptographic keys for printing instructions to be performed later in a print phase may not be made available until previous instructions have already been performed successfully and in a satisfactory manner. In embodiments, server computer 230 can initiate cancellation of a print by a 3D printer at any point during a print phase.

It is noted, that pre-downloading the entirety of print instructions for a 3d printed object in encrypted form and according to the manner described above may have additional benefits other than security, such as convenience and reliability of use. Storing the entire encrypted instructions rather than “streaming” the instructions (as done in prior solutions) eliminates the need for maintaining a large or high data transfer network connection. This is of significant importance, as many prints may need an excess of 3 hours to complete. The solution provided herein minimizes work and bandwidth consumption while printing, while still maintaining necessary print control from the server. Additionally, most 3D printers operate on small memory devices (smaller than size of typical g-code file), and as such, the solution herein provides for an optimal way to continue printing if internet connection is lost. Furthermore, this method can also enable partial printing of 3-dimensional objects that may be used to entice users to buy the remaining portions of the objects. For example, the first printed portions of a toy may incorporate one play aspect, while the remaining portions of the toy may incorporate additional play aspects, such as accessories that a user may wish to buy.

Furthermore, in embodiments, delivery of cryptographic keys from the server computer to the 3D printer may be dependent upon one or more authorization factors. These may include time-dependent authorization factors, whitelist authorization factors, payment-based authorization factors, and task-based authorization factors. Analysis of a requesting printer's authorization factors may provide additional security and protection against “spoofing” or unauthentic requestors that create “fake printers” that may actually be generic computing devices. In embodiments, the analysis may involve testing the validity of the authorization factor, or performing a form of validation test based on the authorization factor, as described further below.

Time-dependent authorization factors may comprise limiting delivery of a cryptographic key required for decryption of printing maneuvers to a particular window of time. For example, a particular 3-dimensional object may only be available to users for a limited period of time or a user may be limited from printing too many objects during a short span of time. As such, the decryption key may not be delivered until the server computer 230 validates that the required time duration has passed. In other examples, the user may establish with the server computer ahead of time when they want to print, and the time-dependent authorization may add additional security that prevents unauthorized users who may not know the established print time from posing as user 201 and attempting a print. For example, the user 201 may set a print time and/or date using user device(s) 202, which may communicate to the server computer 230 a specific time window for which a decryption key should be made available and for which other times are invalid. In some embodiments, the server computer may send a message to the user 3D printer 211 or user device(s) 202 to inform the user that printing is not authorized at the current time (e.g. “printing unauthorized—invalid time”) or in some implementations may simply ask the user to wait and inform them of the authorized time period (e.g. “please wait 5 min.”). In other examples, the time-dependent authorization factors may include limited release implementations. For example, the printing of a particular toy may be limited to the day before a particular movie relating to the toy may be released, or the day a holiday or other significant date has arrived, such as Christmas, New Years, Chinese New Years, etc. In such implementations, the 3-dimensional object may be a toy that relates to the significant event, holiday, or event (e.g. a 3-dimensional gift or greeting).

Whitelist authorization factors may comprise limiting print of a particular 3D model to select users or printers on a “white list”, which may be used as a reference in determining that a requestor is trustworthy. For example, a user can select a model for printing, and the server can decide if the printer and/or user has permission to print the model based on a confirmation of the hardware ID (e.g. MAC address) of the authorized 3D printer. In other words, a server computer may reference the white list and perform a validation test in which the server looks up the hardware ID of the 3D printer and checks if the 3D printer is listed and valid. Furthermore, the server computer 230 may remove a particular 3D printer from the whitelist so as to reject a request for download or for decryption key delivery. For example, if a particular printer makes several requests within a short time span or executes other suspicious behavior its hardware ID may be removed from the whitelist. This may be done in conjunction with monitoring other identifiable information relating to requesting printers that may be stored in print service database(s) 230A. For example, based on network statistics (e.g. suspicious traffic or unusually high-volume traffic at a particular locations or geographic regions) the server computer may remove groups of 3D printers with certain IP addresses associated with certain areas of the network. Network security techniques may be used to draw connections between suspicious/risky devices and used to remove entire clusters of printers from the white list. In other examples, invalid or expired user accounts, user IDs, payment information, etc. may be reason for removal from the whitelist. It is noted, that one advantage of the cryptographic key and whitelist authorization factor combination, is that a bad actor could not pull down the entirety of print files from the service provider at once without waiting for the full download time for all of the toys. For example, if the bad actor wished to monitor the prints of multiple printers in parallel over the network to infer sensitive information such as keys, instructions, account information, authorization/authentication codes, etc., they would be unable to do so as they would need to know which printers were included on the whitelist, in addition to obtaining the keys. Thus, embodiments of the invention additionally provide a method of distributed security.

Payment-based authorization factors may comprise restricting print of a 3-dimensional object until payment for the 3-dimensional object has been successfully processed. In embodiments, encrypted printing instructions may be downloaded by a 3D printer, and the cryptographic key required for decryption may be delivered upon successful payment/purchase of the toy has been completed. For example, the server computer 230 may wait until a user 201's payment credentials have been authorized before delivering the decryption keys to user 3D printer 211. In certain implementations, the user 201 may supply payment credentials such as credit card information and the like to the server computer 230 over network 240 using user device 202. In similar implementations, confirmation of payment may be sent from the server computer 230 to the user device 202.

Task-based authorization factors may comprise authorizing a print dependent on the completion of a predetermined task. For example, the predetermined task may involve correctly performing initiation of a print download by the user 201, as prompted by the system to the user. In specific examples, the user may be asked to solve a riddle or to play and successfully complete a game. In certain implementations, the riddle or game may be provided to the user 201 via user device(s) 202 and the user 201's inputs (i.e. answer to riddle or game inputs) may be sent by the user device(s) 202 over network 240 to server computer 230 for validation. In yet another implementation, the predetermined task may be completion of a two-factor authentication process. For example, validation of one or more authentication codes sent to different accounts of user 201 or to different devices of user device(s) 202 may be required. In one embodiment, the task-based authorization factor may be implemented as a choose your own adventure game. In such an implementation, subsets of printing instructions may be modified or substituted depending on user inputs supplied by the user 201 to a video game played in parallel with the printing process. For example, the 3D printer may be in the process of printing a toy avatar and modifications to the avatar made in a video game, such as costume changes, accomplishment of missions and/or milestones, or other in-game activities, may be reflected in the finally printed product. In one specific example, the user 201 may be completing a biography (bio) about themselves or their avatar as the 3-dimensional is being printed, and the user 201's answers may be used to configure or substitute the printing instruction, such as replacing print of one accessory for another (e.g. ‘favorite sport=hockey; replace “baseball bat print set” with hockey stick print set’).

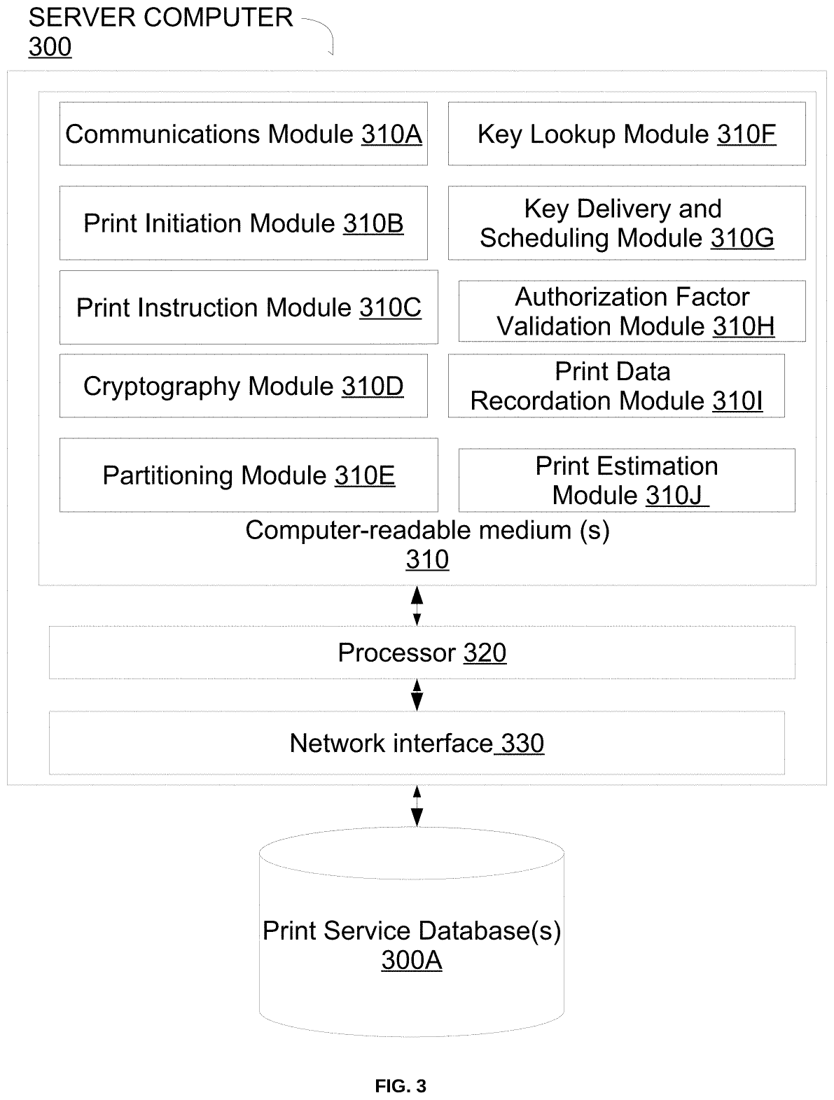

FIG. 3 shows a block diagram of a server computer for enabling secure 3D printing according to embodiments. Server computer 300 shown may be the same server computer as server computer 230 of FIG. 2. Server computer 300 may comprise one or more computer-readable medium(s) 310, at least one processor 320, and at least one network interface 330. Network interface 330 may comprise one or more communication interfaces for exchanging messages over a network, such as network 240 of FIG. 1. For example, the network interface may be a hardware interface allowing for interfacing through protocol layers and for connecting the server computer to the network 240. As one particular example, the network interface may allow for connections through internet protocol, as such through a LAN adapter or ethernet connection. Furthermore, server computer 300 may be coupled to, integrated with, and/or have access to one or more databases, including print service database(s) 300A. Print service database(s) 300A may comprise print service database(s) 230A, in addition to any number of databases storing data utilized in the tasks performed by server computer 300, as further described below.

Processor 320 may comprise one or more computer processors for performing tasks. For example, processor 320 may comprise one or more central processing units (CPU), graphics processing units (GPU), or combinations thereof. Computer-readable medium(s) 310 may comprise one or more memory storage devices, such as RAM, DRAM, ROM, FLASH Memory, to name a few. In embodiments, computer-readable medium(s) 310 may store instructions executable by processor 320 in the form of modules of computer code. Computer-readable medium(s) 310 may comprise communications module 310A, print initiation module 310B, print instruction module 310C, cryptography module 310D, partitioning module 310E, key lookup module 310F, key delivery and scheduling module 310G, authorization (auth) factor validation module 310H, print data recordation module 310I, and print estimation module 310J.

Communication module 310A may comprise instructions for sending, receiving, forwarding, formatting, and reformatting messages communicated over a network through network interface 330. In various implementations, the communications may be facilitated through a communications protocol, such as those known in the art. For example, the communications protocol may include internet protocols and/or proprietary protocols, such as those establishing communications over WiFi, Bluetooth, RFID, and the like.

Print initiation module may 310B may comprise instructions for initiating a print phase of an individual 3-dimensional object. Print phases may be initiated in response to a command received from a user device (e.g. user device 202 of FIG. 2) and/or from a 3D printer (e.g. printing apparatus 100, user 3D printer 211, other user 3D printers 222, 3D printer 400). For example, the user 3D printer may generate and send a request to initiate printing of a particular 3-dimensional object. In a particular example, user 201 may select a catalogue of 3-dimensional objects available for print through the print service provided by the server computer 300, and may use user device 202 to select for print the object of his or her choosing. In certain embodiments, print instructions for the 3-dimensional object may be pre-stored in a memory of the 3D printer in encrypted form, and a selection by the user to initiate print of the 3-dimensional object may identify the object and may comprise a signal to the server computer 300 for sending one or more cryptographic keys for decrypting the print instructions so that the 3D printer may read, execute, and perform the required printing maneuvers.

Print instruction module 310C may comprise instructions for generating print instructions executable by a 3D printer. The server computer 300 may generate instructions through analysis of a 3D model of the 3-dimensional object. The analysis may include an analysis of build feasibility, build material, geometry, shape, and volume. The analysis may be compared to printing maneuvers that the 3D printer on which printing is initiated for, so as to determine the sequence of maneuvers required for building a 3-dimensional object that matches the analyzed 3D model.

Cryptography module 310D may comprise instructions for performing cryptographic operations. The cryptographic operations may include encrypt and decrypt operations, either through symmetric or asymmetric encryption. Furthermore, the cryptographic operations may include various mathematical operations utilized in common encryption and/or decryption processes. For example, these operations may include hashing, random number generation, random data generations (salts, seeds, nonces, etc.), key generation, and the like. Furthermore, the cryptography module 310D may comprise instructions for key management, per the encryption scheme that is utilized. Examples of encryption schemes that may be utilized include public key, private key, SHA-256, RSA, to name a few examples.

Partitioning module 310E may comprise instructions for partitioning a set of printing instructions into subsets and/or partitioning encrypted printing instructions into encrypted parts. In embodiments, the complete set of printing instructions for printing a 3-dimensional object may be partitioned into subsets, which may each be encrypted using a different cryptographic key. Furthermore, delivery of each decryption key to a 3D printer may occur at separate and individually scheduled points during a print phase of the 3D printer printing the 3-dimensional object. Even further, delivery of each cryptographic key may be subject to validation of an authorization factor and/or other status checks. As such, security and protection of rights associated with creation and distribution of 3-dimensional objects may be enhanced and protected, while theft, misuse, and unauthorized access, printing, and/or modification may be limited and more handily prevented. Partitioning of instructions into each subset may be based on number of lines of code (e.g. predetermined number of lines per subset), time estimates (e.g. predetermined number of estimated print min/hours per subset), and/or characteristic element of the 3-dimensional object (e.g. subsets corresponding to feet, legs, torso, head; bottom, middle, top, etc.).

Key lookup module 310F may comprise instructions for looking up one or more cryptographic keys that correspond to a set of printing instructions and/or encrypted parts relating thereto. For example, keys may be referenced in a mapping table in which each subset of encrypted printing instructions may be linked to its corresponding decryption key and the location or address for retrieving the decryption key. In other examples, the key lookup may be a lookup of a certain cryptographic operation, encryption data, or other cryptographic element that may be required to perform the decryption, such as a shared secret or the like. In one implementation, key lookup module 310F may comprise a hash table.

Key delivery and scheduling module 310G may comprise instructions for transmitting cryptographic keys to one or more 3D printers. In embodiments, delivery of cryptographic keys to a 3D printer during a print phase may be coordinated according to a delivery schedule, such as a schedule based on an estimate of print instruction completion time (e.g. deliver decryption for next subset of instructions when previous subsets are completed), based on pre-set times, and/or completion of status checks or validation of authorization criteria. In embodiments, the authorization criteria may comprise authorization factors, such as time-dependent factors, whitelist factors, task-based factors, and payment-based factors, as described earlier in the description.

Auth factor validation module 310H may comprise instructions for validating one or more authorization factors. As mentioned above, in embodiments, when print of a particular 3-dimensional object is requested, authorized transmission of cryptographic keys to a 3D printer for printing the object may be depend on the validity of an authorization factor that should be analyzed, provided, and/or tested by the server computer 300. As such, auth factor validation module 310H may comprise instructions for validation testing time-dependent factors, whitelist factors, task-based factors, and/or payment-based factors. This may include instructions for monitoring the current time and time durations passed, referencing a white list of 3D printers for valid hardware identifiers, monitoring completion of a task by a user or an indication that the task has been completed from a user device, validating payment information, authorizing a payment transaction, and/or receiving payment confirmation.

Print data recordation module 3101 may comprise instructions for recording print statistics and other print data during a printing process and storing the print data in a database of historical print information. The historical print information may comprise recorded data for previous prints, such as those of other 3D printers (e.g. other 3D printers 222 of FIG. 2). The recorded data may include time and date for prints, identifying information of 3D printers that performed the prints (e.g. hardware ID, printer type, printer model, etc.), the 3-dimensional objects that were printed, and various timestamps for the completion of various printing maneuvers throughout a printing process. Updates to the historical print information may be made periodically by the server computer 300 after each print, depending on capacity (e.g. network capacity, processing capacity, and/or memory capacity). The historical print information may stored in a database, such as print service(s) database 230A of FIG. 2. The database can be periodically refreshed to clear up storage. For example, the server computer 300 may be configured to only maintain a pre-selected number of print records for each print of a particular 3-dimensional object (e.g. only cache the last 10 prints or remove older prints beyond the last 10 from the database). In such an implementation, the server computer 300 is able to update faster, which may be suitable for when print times do not deviate greatly from printer to printer. In other implementations, a time period criteria may be utilized for determining the update and refresh of the database. For example, the server computer 300 may be configured to maintain the last 6 months of historical print data. In some embodiments, the update may be executed by running a script for every print performed on every 3D printer in communication with the server computer 300 through the 3D printing service. The server computer may be configured to receive a report of executed prints regularly (e.g. 3D printers 211 and 222 sends weekly report of completed prints to server computer 230).

Print estimation module 310J may comprise instructions for estimating print times. Historical information can be used by the server computer 300 to map out printing statistics, determine trends, and form predictions. Statistical analyses can be used to estimate print times based on previously performed prints that are similar to the one that is being requested. The server computer 300 may perform statistical operations on the historical print data that is recorded according to the instructions of print data recordation module 3101. For example, printing times can be estimated as the median print time of the last 10 prints of a particular 3-dimensional object that was printed by various 3D printers connected to the print service. Furthermore, statistical operations may include determining outliers and excluding them from analysis when performing a print time estimate. For example, the median print time may only consider historical prints within 2 standards of deviation from the mean. Thus, calculations of estimated print times may not be overly affected by anomalous print times, such as those performed by malfunctioning printers, printers with a poor network connection, and/or printers with corrupted data or corrupted reports. In other implementations, print times may first be pre-calculated based on the number of lines of code for printing instructions, the estimated motor speed of a 3D printer, or the amount of material that will be sent through for print of the 3-dimensional object. The pre-calculation may be used to further identify anomalous 3D printers whose print data should not be used as historical data for an estimate. For example, if a 3D printer has a final print completion time that varies greatly form the pre-calculated estimate, the server computer 300 may assume that an error occurred that altered the print process and may exclude the printer's reported times from statistical analyses.

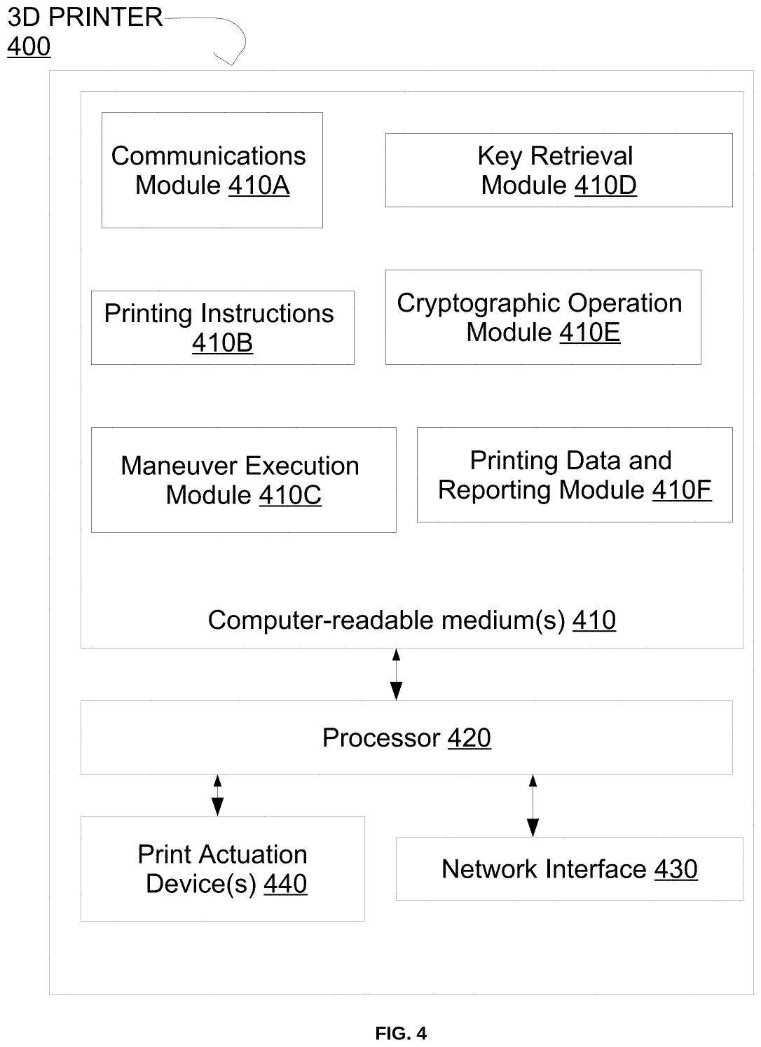

FIG. 4 shows a block diagram of a secure 3D printer according to embodiments. 3D printer 400 shown may be the same 3D printer as printing apparatus 100 of FIG. 1 and user 3D printer 211 of FIG. 2, and may be the same or similar 3D printer as any one of the other 3D printers 222 of FIG. 2. 3D printer 400 may comprise one or more computer-readable medium(s) 410, at least one processor 420, at least one network interface 430, and one or more print actuation device(s) 440. The one or more print actuation device(s) 440 may comprise actuators and various electromechanical devices for performing printing maneuvers. For example, printing actuation device(s) 440 may include the gantry device of the printing apparatus 100 of FIG. 1, and various electromechanical devices for controlling the flow rate of material through nozzle 40 and for controlling the movement of the build base 10 and the print head 40. In embodiments, configurable control of the print actuation device(s) 440 during a print phase of a 3-dimensional object may be controlled by the processor 420. The network interface 430 may comprise one or more communication interfaces for exchanging messages over a network, such as network 240 of FIG. 1. Network interface 330 may comprise one or more communication interfaces for exchanging messages over the network. For example, the network interface may be a hardware interface allowing for interfacing through protocol layers and for connecting the server computer to the network 240. As one particular example, the network interface may allow for connections through internet protocol, as such through a LAN adapter or ethernet connection. In other examples, the network interfaces may include near field communication (NFC) interfaces, RFID interfaces, Bluetooth interfaces, cellular network interfaces, etc. Processor 420 may comprise one or more computer processors for performing tasks. For example, processor 420 may comprise one or more central processing units (CPU), graphics processing units (GPU), or combinations thereof. Computer-readable medium(s) 410 may comprise one or more memory storage devices, such as RAM, DRAM, ROM, FLASH Memory, to name a few. In embodiments, computer-readable medium(s) 410 may store instructions executable by processor 420 in the form of modules of computer code. Computer-readable medium(s) 410 may comprise communications module 410A, printing instructions 410B, maneuver execution module 410C, key retrieval module 410D, cryptographic operation module 410E, and print data and reporting module 410F.

Communications module 410A may comprise instructions for sending, receiving, forwarding, formatting, and reformatting messages communicated over a network through network interface 430. In various implementations, the communications may be facilitated through a communications protocol, such as those known in the art. For example, the communications protocol may include internet protocols and/or proprietary protocols, such as those establishing communications over WiFi, Bluetooth, RFID, and the like.

Printing instructions 410B may comprise instructions for printing a 3-dimensional object. The printing instructions may include specific maneuvers that the actuation devices 440 of 3D printer 400 performs in sequence to form or “print” the 3-dimensional object. As an example, for an FDM 3D printer, the printing instructions may include horizontal and vertical movements of a print head along a gantry, controlled flow and extrusion of material through a nozzle, and controlled movement of a build base as extruded material accumulates onto a print bed seated on the build base to form the 3-dimensional object.

Maneuver execution module 410C may comprise instructions for executing print maneuvers. This may include instructions for controlling the one or more actuation devices 440 to perform maneuvers specified by a given set of printing instructions. For example, the instructions may include programmable logic for moving a printer head across a gantry of the 3D printer 400, controlling flow rate of extruded material through a nozzle, moving a print base towards or away from the nozzle, and other controlled movements for printing and forming a 3-dimensional object into its planned model/design. In one embodiment, the programmable control may be encoded in a manner that is unique to the 3D printer 400, such that the 3D printer 400 may perform individualized printing maneuvers that may only form the desired 3-dimensional object if executed using the individual 3D printer 400. As such, encoded g-code files cannot be used to successfully print a 3-dimensional object illegally using another 3D printer of similar model or build, even if the encoded g-code file were to be sniffed out or stolen during the print phase by an attacker.

Key retrieval module 410D may comprise instructions for retrieving cryptographic keys. This may include instructions for requesting a particular cartographic key that can be used to decrypt printing instructions for an individual 3-dimensional selected for print by a user. For example, the 3D printer 400 may send a message to a server computer (e.g. server computer 300, 230) containing its hardware identifier and an identifier for the 3-dimensional object selected and/or the particular point in the print phase so that the next set of instructions in the print phase may be decrypted. In one embodiment, keys may be pushed to the 3D printer 400 by the server computer at specific points during the print phase by the server computer, either according to a pre-set schedule or a schedule that is calculated in real-time by the server computer in order to optimize the printing process. For example, the 3D printer 400 may send status checks to the server computer, which may be used to time the transmission/retrieval of each cryptographic key.

Cryptographic operation module 410E may comprise instructions for performing cryptographic operations. The cryptographic operations may include encrypt and decrypt operations, either through symmetric or asymmetric encryption. Furthermore, the cryptographic operations may include various mathematical operations utilized in common encryption and/or decryption processes. For example, these operations may include hashing, random number generation, random data generations (salts, seeds, nonces, etc.), key generation, and the like.

Print data and reporting module 410F may comprise instructions for generating and storing data relating to print processes during a print phase, and for reporting the print data that is generated and stored. This may include instructions for recording maneuvers performed, completion times, statuses, and for packaging the print data into a report for transmission to a print service (e.g. to a server computer 300, 230) over a network.

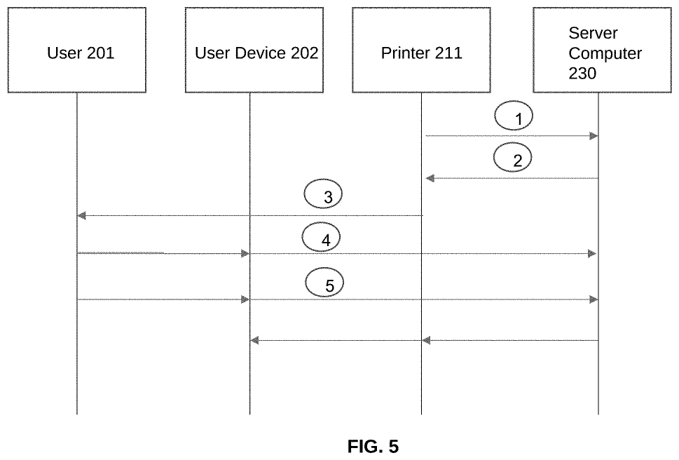

FIG. 5 shows a swim lane diagram for securely connecting to a 3D printing service according to embodiments. The following may allow for connection of a user (e.g. user 201 of FIG. 2) to a printing service or for connection of a user device (e.g. user device 202) to a 3D printer (e.g. printing apparatus 100, user printer 211, 3D printer 400). The following is performed in conjunction with communications with a server computer over a network (e.g. server computer 230, network 240 respectively). At step 1, printer 211 makes a connection to server with credentials, including a hardware identifier that is specific to printer 211. At step 2, server computer 230 sends a connection token to printer 211. In some embodiments, the server can choose not to send the connection token if the hardware ID of printer 211 is not present on a whitelist. At step 3, printer 211 communicates to user 201 and/or user device(s) 202 its application token. In one embodiment, the connection token may be displayed visually to the user via a display of printer 211, such as an LCD coupled to the printer body. In another embodiment, the connection token may be transmitted from the printer 211 to the user device 202 via a communication interface, such as through a serial communication port, WiFi, or Bluetooth. At step 4, the user 201 logs in to his or her account through an authentication/log-in process initiated with server computer 230, in which the user 201 presents his or her account credentials to server computer 230 over network 240 via user device 202. At step 5, the user device 202 presents the connection token to the server computer 230. In one embodiment, this may be done by the user, such as in the case of the connection token being visually displayed by printer 211. In another embodiment, the may be done at the application level, in which an application of the user device 202 stores and transmits the connection token it received from the printer 211 directly to the server computer 230 or by auto-populating the connection token information into the necessary input field. Upon receipt of the connection token, the server computer 230 may establish the secure connection between the user device 202 and the printer 211.

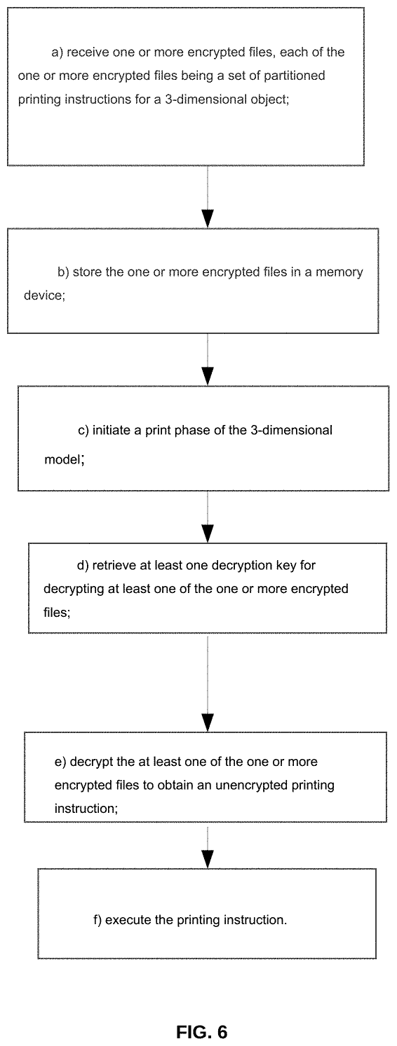

FIG. 6 shows a flow diagram of a method for secure 3D printing according to one embodiment. Step a) comprises receiving one or more encrypted files, each of the one or more encrypted files being a set of partitioned printing instructions for a 3-dimensional object. Step b) comprises storing the one or more encrypted files in a memory device. Step c) comprises initiating a print phase of the 3-dimensional model. Step d) retrieving at least one cryptographic key for decrypting at least one of the one or more encrypted files. Step e) comprises decrypting the at least one of the one or more encrypted files to obtain an unencrypted printing instruction. Step f) comprises executing the printing instruction.

In one embodiment, the method may further comprise executing a first set of printing instructions for the 3-dimensional model and requesting, during or upon completion of the first set of printing instructions, a cryptographic key for a second set of printing instructions for the 3-dimensional model. The method may additionally comprise receiving the cryptographic key for the second set of printing instructions, and using the cryptographic key for the second set of printing instructions to decrypt and reveal the second set of printing instructions.

Additionally, and in conjunction with security methods described above, the following may provide for a more convenient and reliable printing process. The following describes embodiments for sending a customized printer file to a 3D printer 211 by a server computer 230, specifically according to a “One-click” printing process for users. An important aspect of the one-click printing process is that the user is never required to input any specific settings, as they may be pre-determined according to the connected printer. The connected printer can also provide necessary parameters for determining the correct file to send. Based on the hardware identifier of printer 211, server computer 230 can determine exact slicer settings, such as by referencing a mapping table or referential database of print service database(s) 230A. The exact slicer settings for the printer 211 may be inputted based on valid printers and/or valid parameters established for the 3D printing service by server administrators. A user 201 may select to print a 3D model, and server computer 230 may send the correct file having the exact predetermined slicer settings for the printer 211 based on the build, type, model, individual printer, or individual account, as determined from an association of hardware identifier being linked to the predetermined slicer settings in print service database 230A. If the server computer 230 determines that no predetermined slicer settings exist for the printer or that no slicer setting are currently associated with the hardware identifier, it may determine the necessary slicer settings based on parameters received from printer 211 and may store the necessary slicer settings in print service database(s) 230A for later reference and use.

In one embodiment, to further aid in providing a convenient and reliable print process, a method of estimating a print time of a 3-dimensional object. In prior systems, print times are determined based on simulations performed a g-code file, and require the printer to send updates up to a server during a print phase as to its current state. In current embodiments presented herein, estimates are based on historical data which may be more reliable indicators and may require less data to be sent to the printing service. According to current embodiments, server computer 240 sends a g-code file to printer 211, and the printer 211 later sends a log of when certain g-codes were completed and/or the total time of the entire g-code file execution. The printer tells the server when it starts, ignores heating up time and other variable actions. The printer tells the server when it ends, completes, or terminates printing. The server can then use the new print time along with all other prints for the same file on the same type of printer to determine real print time. For example, the server can use a log from printer 211 and other 3D printers 222. In one embodiment, the determination may be based on a calculation of the median print time. In another embodiment, outliers can be removed from the calculation. These calculations can be performed live during print phases or after a print phase by running a script later on the server.

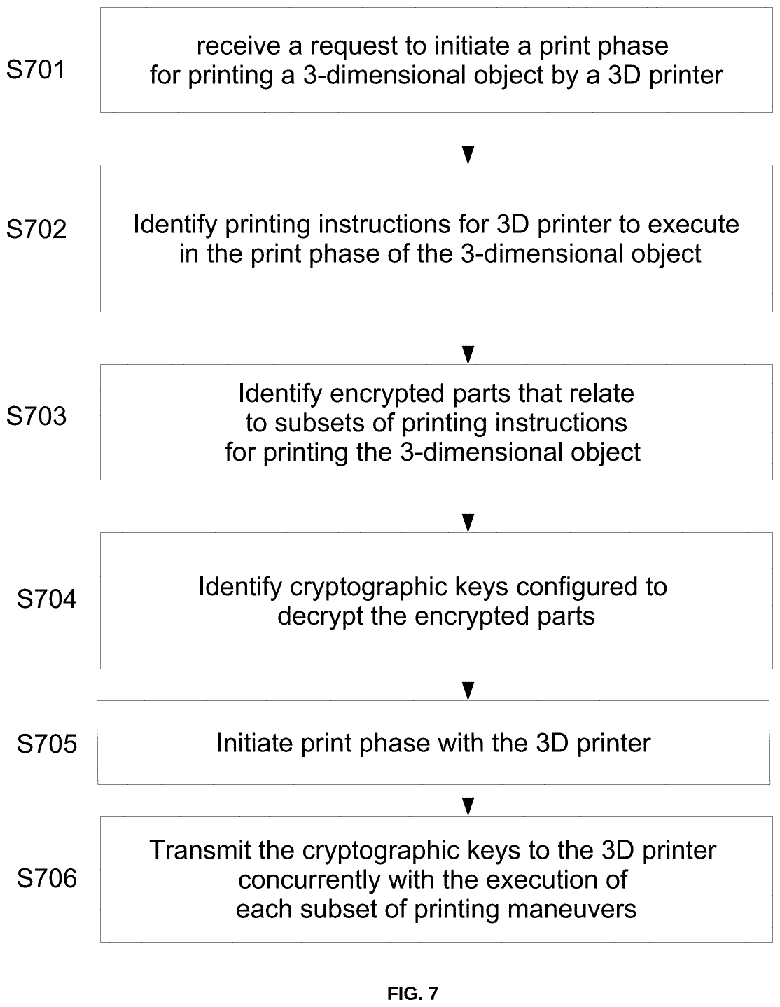

FIG. 7 shows a flow diagram of a method for enabling a secure 3D printing process according to embodiments. The method may be performed by a server computer that provides printing services to 3D printers over a network. For example, the server computer may be server computer 300 of FIG. 3 and/or server computer 230 of FIG. 2.

At step 701, the server computer receives a request to initiate a print phase for printing a 3-dimensional object by a 3D printer. The request may be a message generated from a user device or from a 3D printer in communication with the printing service. For example, a user may use a tablet device to view a catalog of 3-dimensional objects available for print (e.g. toys, trinkets, tools, etc.) and may select the a particular 3-dimensional object he or she may with to print. Selections may be formatted into a request comprising an identifier for the 3-dimensional object and an identifier for the 3D printer on which the object is to be printed (e.g. hardware ID of printer). For example, messaging with the print service may be handled using an application on the user device. Similarly, identifying information of a user, such as account information or device ID of the user device may be communicated in the request as well. When the server computer receives the request, the server computer may proceed with the method to initiate the print phase.

At step 702, the server computer identifies printing instructions for the 3D printer to execute. The server computer may examine the received request and identify information relating to the individual 3-dimensional object and to the individual 3D printer that is identified in the request. Similarly, any identifying information of the user provided may be examined as well. From the identifying information, the server computer may determine the printing instructions that may need to be performed by the 3D printer in order to form the 3-dimensional object requested. For example, the server computer may evaluate a 3D model of the 3-dimensional object and determine the printing instructions that are available to the 3D printer, material used, and other printer characteristics or print characteristics which may allow the 3D printer to print an object according to the 3D model.

At step 703, the server computer identifies encrypted parts that relate to subsets of printing instructions for the 3-dimensional object. In one embodiment, printing instructions for the 3-dimensional object may be stored onto the 3D printer in encrypted form, and the server computer may reference a lookup table that links the printing instructions stored on the 3D printer to its encrypted parts and its corresponding keys. The server computer may identify each encrypted part that requires a separate and different decryption key.

At step 704, the server computer identifies cryptographic keys configured to decrypt the encrypted parts. For example, the server computer may reference a mapping table that correlates encrypted parts to their corresponding decryption keys. The server computer determines a correspondence between cryptographic keys and the encrypted parts.

At step 705, the server computer initiates the print phase with the 3D printer. The server computer may send a signal to the 3D printer to begin printing according to the stored instructions. The 3D printer may be configured to retrieve the cryptographic keys from the server computer once the print phase has been initiated in conjunction with performing each set of printing maneuvers.

At step 706, the server computer transmits the cryptographic keys to the 3D printer concurrently with the execution of each subset of printing maneuvers. The server computer may transmit each decryption in key at a predetermined points during the print phase. As previously mentioned, each cryptographic key may correspond to a different part of the printing process, such as different parts of the 3-dimensional object (e.g. beginning, middle, and end or base plate first, followed by other parts, and so on), particular points in the printing instructions, and/or particular points in the print phase which may be optimal. In one embodiment, the cryptographic keys may be correspond to random parts of the printing instructions. For example, a random number generator can be used to partition into a random quantity of parts or 10-15 random intervals in the printing instructions. In one embodiment, partitioning of instructions and transmission of cryptographic keys may be set to minimize network latency. For example, if network conditions are good (e.g. meet a reliability or latency standard or network speed is above a pre-defined threshold), then a greater number of keys may be delivered in consecutive fashion (e.g. smaller partitions spaced closer together in the printing process). However, if network conditions are poor, the server computer may give more leeway, and set a buffer for delivering each key (e.g. each key is delivered once every 30 min.). Furthermore, key transmissions may be based on an estimate of completion times for print maneuvers. For example, the server computer may transmit a cryptographic key for a subset of print instructions just before the previous subset is estimated to be completed. In one particular example, the server computer may estimate how long it will take a 3D printer to print the feet of a 3-dimensional object, and may then transmit cryptographic keys for the legs just before the feet are estimated to be completed (e.g. 10 min. before completion of the feet).

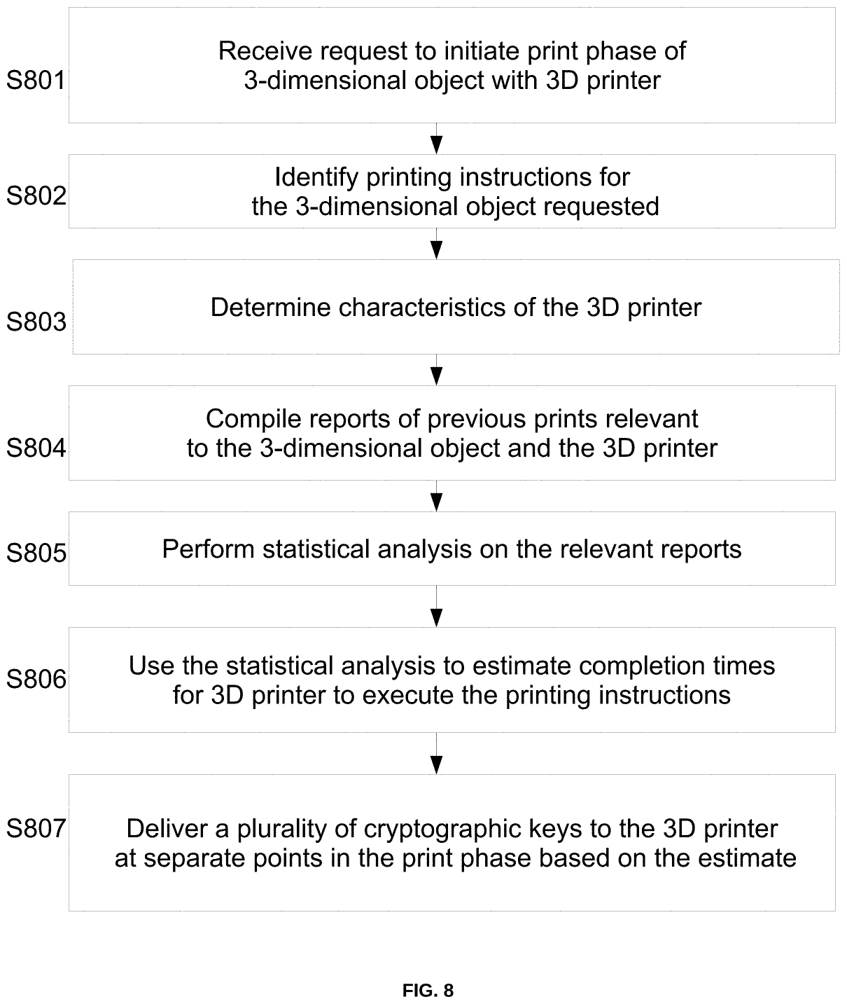

FIG. 8 shows a flow diagram of a method for estimating a print time according to one embodiment. The method may be performed by a server computer that provides printing services to 3D printers over a network. For example, the server computer may be server computer 300 of FIG. 3 and/or server computer 230 of FIG. 2.

At step S801, the server computer receives a request to initiate a print phase of a 3-dimensional object with a 3D printer. The request may be a message generated from a user device or from a 3D printer in communication with the printing service. For example, a user may use a tablet device to view a catalog of 3-dimensional objects available for print (e.g. toys, trinkets, tools, etc.) and may select the a particular 3-dimensional object he or she may wish to print. Selections may be formatted into a request comprising an identifier for the 3-dimensional object and an identifier for the 3D printer on which the object is to be printed (e.g. hardware ID of printer). For example, messaging with the print service may be handled using an application on the user device. Similarly, identifying information of a user, such as account information or device ID of the user device may be communicated in the request as well. When the server computer receives the request, the server computer may proceed with the method to initiate the print phase.

At step S802, the server computer identifies printing instructions for the 3-dimensional object requested. The server computer may examine the received request and identify information relating to the individual 3-dimensional object and to the individual 3D printer that is identified in the request. Similarly, any identifying information of the user provided may be examined as well. From the identifying information, the server computer may determine the printing instructions that may need to be performed by the 3D printer in order to form the 3-dimensional object requested. For example, the server computer may evaluate a 3D model of the 3-dimensional object and determine the printing instructions that are available to the 3D printer, material used, and other print characteristics that may allow the 3D printer to print an object according to the 3D model.

At step S803, the server computer determines characteristics of the 3D printer. The characteristics may include build type, manufacturer, model no., hardware ID (e.g. MAC address), etc. Other characteristics may include characteristics of the 3D printer's actuation devices, such as nozzle temperatures, flow rate, diameter, motor speeds, rpms, torques, etc. Similarly, characteristics of other printer components may also be determined, such as materials used, print bed used, number of prints performed/completed, network connection, etc.

At step S804, the server computer compiles reports of previous prints of relevant to the 3-dimensional object and the 3D printer. In embodiments, each 3D printer connected to the print service may deliver regular status reports containing completion print completion times and records of previously performed prints executed on the individual 3D printer. The reports may be stored in a database accessible to the server computer (e.g. print service database 230A of FIG. 2). The server computer may compare the characteristics of the 3D printer requesting print of the 3-dimensional object and the identification of the 3-dimensional object itself to gather/compile reports that may be relevant to the current print being requested. For example, the 3D printer may extract reports containing records of completed prints of the 3-dimensional object made by other printers similar to the 3D printer that is currently requesting.

At step S805, the server computer performs statistical analyses on the relevant reports. In embodiments, this may include an evaluation of such statistical metrics as mean, median, and/or mode, to name a few examples. For example, the server computer may use the reports to determine the median print time for the last 10 prints of the particular 3-dimensional object by various printers utilizing the print service.

At step S806, the server computer uses the statistical analyses to estimate completion times for the 3D printer to execute the printing instructions. In one embodiment, this may include choosing a statistical metric to use as the estimate. For example, the server computer may utilize the median print time calculated in step S805 as the estimated print time for the requesting printer. Furthermore, the server computer may estimate completion times for subsets of the printing instructions using the statistical analyses. For example, the server computer may determine the median time for completing each part of the 3-dimensional object (e.g. bottom segment, middle segment, top segment).

At step S807, the server computer delivers a plurality of cryptographic keys to the 3D printer at separate points in the print phase based on the estimate. In one embodiment, the 3D printer may deliver a decryption key for a particular set of print instructions just prior to the particular instructions needing to be printed. For example, the decryption key for decrypting a middle segment of 3-dimensional object may be delivered 5 min. before the bottom segment is estimated to be completed. In embodiments, cryptographic keys may be removed from the 3D printer's memory upon use.

Embodiments provide a number of technical advantages, in addition to those already mentioned earlier in the description. The embodiments describe provide greater security over previous methods, and allow a content provider and/or designer of 3-dimensional objects to better protect their creative work from unauthorized use. Furthermore, embodiments narrows the window of opportunity for an attacker to extract cryptographic keys and other useful, sensitive information. In addition, various embodiments of the invention provide greater ease-of-use and entertainment value in addition to security, through the use of interactions that can be facilitated through simple registration processes and interactive play.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A system for secure 3D printing, the system comprising:
a server computer configured to transmit one or more cryptographic keys over a network upon initiation of a print phase, each of the one or more cryptographic keys being unique to individual 3-dimensional objects and unique to individual 3D printers;
a 3D printer configured to print the individual 3-dimensional objects, the 3D printer comprising:
at least one network interface configured to access the network;
one or more actuation devices configured to perform controllable print maneuvers;
a processor configured to execute computer code and printing instructions, the printing instructions being sequences of print maneuvers that form the individual 3-dimensional objects; and
a non-transitory computer-readable medium coupled to the 3D printer and configured to store the instructions executable by the processor, wherein the instructions comprise encrypted printing instructions and computer code for:
receiving, from the server computer during a print phase initiated with the 3D printer, a plurality of cryptographic keys unique to the 3D printer and pertaining to a particular 3-dimensional object amongst the individual 3-dimensional objects;
decrypting encrypted printing instructions for printing the particular 3-dimensional object using the plurality of cryptographic keys pertaining to the particular 3-dimensional object; and
performing the decrypted printing instructions to print the particular 3-dimensional object.

2. The system of claim 1, wherein the encrypted printing instructions are configured as a plurality of encrypted parts each relating to a different subset of the encrypted printing instructions, and wherein each cryptographic key in the plurality of cryptographic keys can only be used to decrypt a corresponding encrypted part within the plurality of encrypted parts.

3. The system of claim 1, wherein transmission of the one or more cryptographic keys by the server compute is dependent upon one or more authorization factors, the one or more authorization factors including at least one of: a time-dependent authorization factor, a whitelist authorization factor, a payment-based authorization factor, or a task-based authorization factor.

4. The system of claim 1, wherein each cryptographic key is transmitted from the server computer to the 3D printer individually and at separately scheduled points within the duration of the print phase of the particular 3-dimensional object.

5. The system of claim 4, wherein the separately scheduled points within the duration of the print phase are determined based on one or more estimates for a completion time for performing the decrypted printing instructions, and wherein the one or more estimates for the completion time are determined based on historical print data for previous printings of the particular 3-dimensional object by other 3D printers having similar characteristics to the 3D printer.

6. The system of claim 1, wherein the server computer is further configured to encode the print maneuvers performable by the one or more actuation devices using an encoding function unique to the 3D printer.

7. The system of claim 1, wherein the server computer is further configured to:
receive from the 3D printer a request to print the particular 3-dimensional object, the request comprising a hardware identifier of the 3D printer;
compare the hardware identifier to a mapping table to determine a configuration of the 3-dimensional object corresponding to the 3D printer;
generate a 3-dimensional model of the 3-dimensional object based on the determined configuration; and
generate the printing instructions pertaining to the particular 3-dimensional object based on the generated 3-dimensional model.

8. A method for enabling secure 3D printing comprising:
receiving a request to initiate a print phase with a 3D printer to print a selected 3-dimensional object;
identifying a plurality of encrypted parts relating to the selected 3-dimensional object, each encrypted part relating to a different subset of printing instructions pertaining to the selected 3-dimensional object;
identifying a plurality of cryptographic keys configured to decrypt the plurality of encrypted parts;
determining a correspondence between one or more cryptographic keys in the plurality of cryptographic keys and each of the encrypted parts relating to the different subsets of the printing instructions;
initiating the print phase of the 3-dimensional object; and
transmitting the one or more cryptographic keys to the 3D printer concurrently with the execution of each of the different subsets of the printing instructions, wherein the 3D printer is configured to use the one or more cryptographic keys to decrypt its corresponding encrypted part and perform the different subsets of the printing instructions.

9. The method of claim 8, further comprising:
prior to transmission of the one or more cryptographic keys, performing a validation test of one or more authorization factors; and
denying access to the one or more cryptographic keys if the one or more authorization factors fails the validation test, wherein the one or more authorization factors includes at least one of a time-dependent authorization factor, a whitelist authorization factor, a payment-based authorization factor, or a task-based authorization factor.

10. The method of claim 8, further comprising:
prior to transmission of the one or more cryptographic keys, performing a validation test of one or more authorization factors; and
transmitting the one or more cryptographic keys if the the one or more authorization factors passes the validation test, wherein the one or more authorization factors includes a task-based authorization factor.

11. The method of claim 10, further comprising:
receiving an indication of a completed task relating to the task-based authorization factor; and
substituting one of the different subsets of the printing instructions based on the completed task.

12. The method of claim 8, wherein each cryptographic key is transmitted to the 3D printer individually and at separately scheduled points within the duration of the print phase of the individual 3-dimensional object.

13. The method claim 12, further comprising partitioning encrypted printing instructions into the encrypted parts, wherein the partitioning is performed according to characteristic elements of the individual 3-dimensional object.

14. The method of claim 12, further comprising partitioning encrypted printing maneuvers into the encrypted parts, wherein the partitioning is based on one or more estimates for a completion of the printing instructions.

15. The method of claim 14, wherein the one or more estimates for the completion time are determined based on historical data for previous printings of the individual 3-dimensional object by other 3D printers having similar characteristics to the 3D printer.

16. A server computer configured to enable secure 3D printing, the server computer comprising:
at least one network interface configured to access a network;
a processor;
a non-transitory computer-readable medium storing instructions executable by the processor, the instructions including a method comprising the steps of:
receiving, over the network, a request to initiate a print phase of an with a 3D printer;
identifying a plurality of encrypted parts relating to printing instructions of a selected 3-dimensional object, each encrypted part relating to a different subset of the printing instructions that can be performed by the 3D printer when the encrypted part is decrypted;
identifying a plurality of cryptographic keys configured to decrypt the plurality of encrypted parts;
determining a correspondence between one or more cryptographic keys in the plurality of cryptographic keys and each of the encrypted parts relating to the different subsets of the printing instructions;
initiating the print phase of the 3-dimensional object; and
transmitting, over the network, the one or more cryptographic keys to the 3D printer concurrently with the execution of each of the different subsets of the printing instructions, wherein the 3D printer is configured to use the one or more cryptographic keys to decrypt its corresponding encrypted part and perform the different subsets of the printing instructions.

17. The server computer of claim 16, wherein the method further comprises:
prior to transmission of the one or more cryptographic keys, performing a validation test of one or more authorization factors; and
denying access to the one or more cryptographic keys if the one or more authorization factors fails the validation test, wherein the one or more authorization factors includes at least one of a time-dependent authorization factor, a whitelist authorization factor, a payment-based authorization factor, or a task-based authorization factor.

18. The server computer of claim 16, wherein the method further comprises the steps of:
prior to transmission of the one or more cryptographic keys, performing a validation test of one or more authorization factors; and
transmitting the one or more cryptographic keys if the the one or more authorization factors passes the validation test, wherein the one or more authorization factors includes a task-based authorization factor.

19. The server computer of claim 16, wherein the method further comprises the step of:
partitioning encrypted printing maneuvers into the encrypted parts; and
transmitting each cryptographic key to the 3D printer individually at separate points within the duration of the print phase of the individual 3-dimensional object, wherein the partitioning of the encrypted printing maneuvers is based on one or more estimates for a completion of the different subsets of printing instructions, and wherein the separate points for transmitting each cryptographic key are scheduled based on the one or more estimates for the completion of the different subsets.

20. The server computer of claim 19, wherein the method further comprises the steps of:
recording historical data for printing maneuver completion times of previous prints of the individual 3-dimensional object made by other 3D printers having similar characteristics to the 3D printer; and
calculating the one or more estimates for the completion of the different subsets of the printing instructions based on the recorded historical data.
